(19) United States
(12) Patent Application Publication
(10) Pub. No.: US 2004/0183745 A1
(43) Pub. Date: Sep. 23, 2004

(54) Dual display apparatus

(76) Inventor: Jeung-Hie Choi, Ichon-shi (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/750,444

(22) Filed: Dec. 31, 2003

(30) Foreign Application Priority Data
Mar. 20, 2003 (KR) 2003-17571

(51) Int. Cl. G09G 5/00

(52) U.S. Cl. 345/1.1

(57) ABSTRACT

A display apparatus includes a plurality of display panels, each showing different displays; a single display panel driving unit for commonly operating the display panels; and a connection unit for physically and electrically inter-connecting the display panel driving unit with the display panels.

### FIELD OF THE INVENTION

The present invention relates to a display apparatus; and, more particularly, to a display apparatus for use in a folder type phone capable of controlling a plurality of display panels with one driving unit.

### DESCRIPTION OF RELATED ARTS

A display apparatus serves to convert electrical image information into a visual image to be displayed on its screen. Various display apparatus, i.e., a cathode ray tube (CRT), a flat panel display (FPD), a liquid crystal display (LCD), a plasma display panel (PDP) and the like have been researched and developed up to date.

These display apparatuses are employed with a small-sized display unit in various potable terminals, i.e., a mobile phone and the like.

Especially, a display module for use in a conventional display apparatus having two display panels is shown in FIGS. 1A and 1B.

As shown, a conventional dual display module is constituted with two display panels 10A and 10B mounted on a cover of the folder type mobile phone, two display panel driving units 11A and 11B for driving the respective display panels 10A and 10B, coupling units 12A and 12B for shielding and coupling the display panels 10A and 10B and display panel driving units 11A and 11B. Input and output interfaces 13A and 13B are coupled to respective display panel driving units 11A and 11B.

Typically, a first display panel 10A has larger size than that of a second display panel 10B. Such structure mentioned above is usually employed in the folder type mobile phone.

To drive both display panels 10A and 10B of the display apparatus, each of display panel driving unit is integrated in each display panel, and connected to each of the display panels 10A and 10B through each of the coupling units 12A and 12B. Herein, the coupling units 12A and 12B are built with a tape carrier package (TCP). Hereinafter, the coupling units 12A and 12B are referred to as TCP.

The display panel driving units 11A and 11B are mounted on the TCPs 12A and 12B, respectively, and each of TCP is connected to each of display panels 10A and 10B and a central processing unit (not shown). More specifically, one side of each TCP 12A or 12B is tightly connected with each of the display panels, and the other side is connected with the central processing unit (CPU) or a control unit referred to as a host (not shown).

In case that the folder type mobile phone is folded, the first display panel 10A is not driven, but the second display panel 10B is driven. Herein, the second display panel 10B is mounted on an exterior of the corner of the folder type mobile phone and the first display panel 10A is located inside of the folder type mobile phone. Reversely, in case that the folder type mobile phone is unfolded, the first display panel 10A is driven, but the second display panel 10B is not driven. On the other hand, it is possible that both of display panels 10A and 10B are driven concurrently when the folder type mobile phone is unfolded.

As described above, each display panel driving unit is selectively driven depending on the display panel to be operated. Furthermore, in case that the display panels are identical to each other, the display panel driving units have identical functions and configurations. Although the display panels are not identical to each other, for example, a thin film transistor (TFT) panel and a super twisted nematic (STN) panel, the display panel driving units for the TFT and STN panels also have practically identical functions.

However, in case that the aforementioned dual display panel is used for the folder type mobile phone, the display panels are arranged in opposite sides of the cover of the folder type mobile phone, and thereby, requiring two independently integrated display panel driving units. As a result, there is a problem that a packaging cost is increased.

### SUMMARY OF THE INVENTION

It is, therefore, an object of the present invention to provide a display apparatus capable of controlling a plurality of display panels by employing one display panel driving chip.

In accordance with an aspect of the present invention, there is provided the display apparatus, including: a plurality of display panels selectively displayed; a single display panel driving unit for commonly operating the display panels; and a connection unit for physically and electrically inter-connecting the display panel driving unit with the display panels.

### BRIEF DESCRIPTION OF THE DRAWINGS

Other objects and aspects of the invention will become apparent from the following description of the embodiments with reference to the accompanying drawings, in which:

FIGS. 1A and 1B are a diagram showing conventional display module for constituting a typical display apparatus;

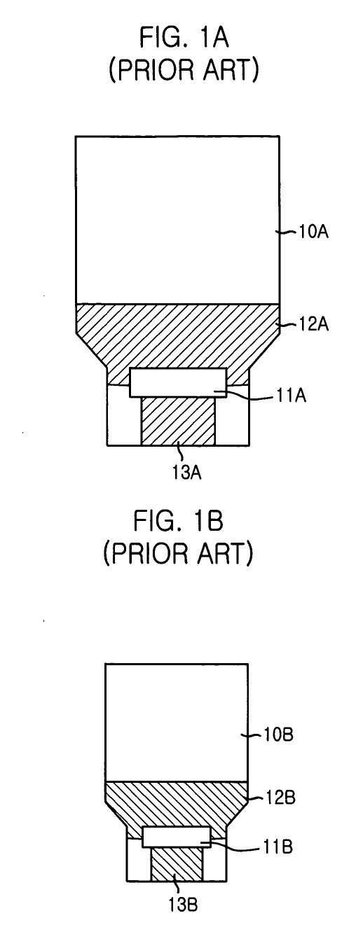

FIGS. 2A and 2B are plane and side views of the dual display apparatus, respectively, in accordance with a preferred embodiment of the present invention;

FIGS. 3A and 3B are plane view showing configurations of the display driving unit, the coupling unit and the I/O interface port in FIG. 2A; and

FIG. 4 is a block diagram showing an example of the display panel driving unit in the display apparatus in accordance with the present invention;

FIG. 5 is a circuit diagram illustrating the voltage generation unit in FIG. 4 in accordance with the present invention;

FIG. 6 is a waveform of the clock signals clka and clkb applied to the voltage generation unit in accordance with the present invention;

FIG. 7 is schematic diagram illustrating the latch unit in FIG. 4 in accordance with the present invention; and

FIG. 8 is a block diagram showing another embodiment of the display panel driving unit in the display apparatus according to the present invention.

### DETAILED DESCRIPTION OF THE PREFERRED EMBODIMENT

Hereinafter, an inventive dual display apparatus capable of obtaining large scale integration and reducing a fabrication cost by employing two display panels with one display panel driving unit will be described in detail referring to the accompanying drawings.

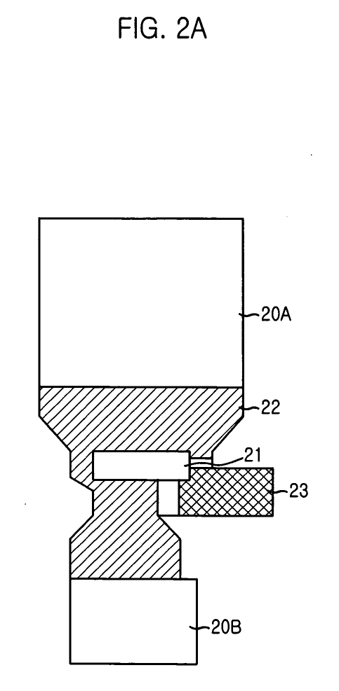

FIGS. 2A and 2B are plane and side views of the dual display apparatus, respectively, in accordance with a preferred embodiment of the present invention. Herein, the dual display apparatus has two display panels.

As shown, the dual display apparatus is constituted with a plurality of display panels respectively having different type display devices, i.e., a first display panel 20A and a second display panel 20B; a display panel driving unit 21 for driving the first and the second display panels 20A and 20B; a coupling unit 22 for physically and electrically inter-connecting the first and the second display panels 20A and 20B with the display panel driving unit 21; and an input/output (I/O) interface port 23.

Herein, various packaging techniques such as a tape carrier package (TCP) method, a chip on film (COF) method, a chip on board (COB) method or a chip on glass (COG) method are carried out for the coupling unit 22.

To drive the first and the second display panel 20A and 20B of the dual display apparatus, since the size of the first display panel 20A is greater than that of the second display panel 20B, there is needed a greater power to drive the first display panel 20A than to drive the second display panel 20B. As shown in FIG. 2A, the first display panel 20A is connected with the second display panel 20B through the coupling unit 22. Herein, the first and second display panels 20A and 20B and the coupling unit 22 are all disposed on one plane.

FIG. 2B shows a side view of the dual display apparatus at the time that the first and the second display panel 20A and 20B shown in FIG. 2A are folded. As shown, the display panel driving unit 21 is located between the first and the second display panels 20A and 20B. At this time, the display panel driving unit 21 can be packaged in a flexible “U” or “S” shape.

Also, rear sides of the first and the second display panels 20A and 20B face each other when the dual display apparatus is folded.

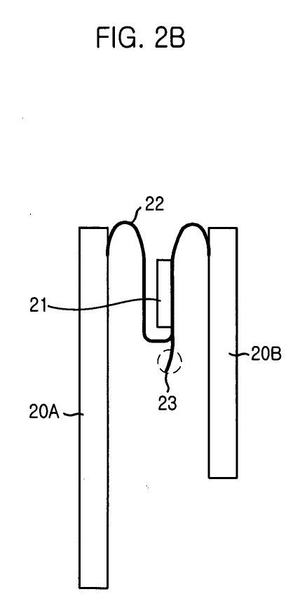

FIGS. 3A and 3B are plane view showing configurations of the display driving unit, the coupling unit and the I/O interface port in FIG. 2A.

As shown, the first display panel 20A is coupled to ‘A’ portion and the second display panel 20B is coupled to ‘B’ portion. Also, the I/O interface port

To operate a plurality of display panels concurrently and alternatively, constitution elements of the display panel driving unit 21 are functionally separated by an operation on/off state of each display panel. At this time, each constitution element included in the display panel driving unit 21 can be controlled by an on-off switching operation.

Also, each of the constitution elements included in the display panel driving unit 21 is shared with the first and the second display panels 20A and 20B and controlled by the on-off switching operation of a channel.

A decoder, a voltage generation unit, a latch unit and a memory unit are the constitution elements of the shared or functionally separated display panel driving unit 21.

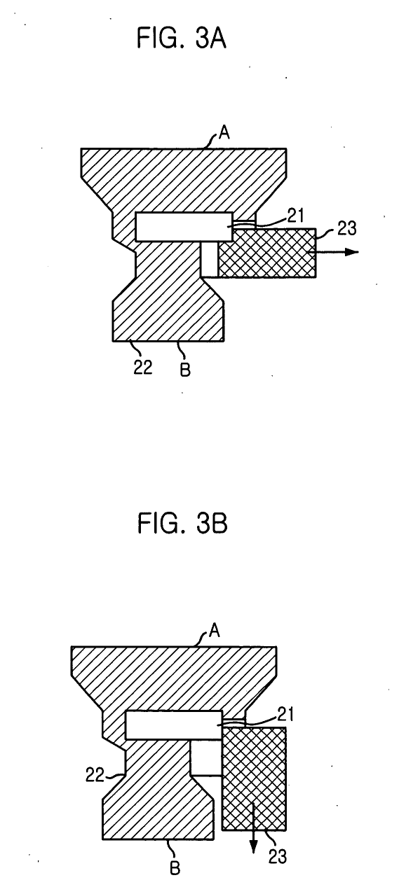

FIG. 4 is a block diagram showing an example of the display panel driving unit 21 in the display apparatus in accordance with the present invention.

The display panel driving unit 21 includes a CPU interface control unit 410 for controlling an operation of the display panel driving unit and a display panel control unit 409 operated under control of the CPU interface control unit 410, a memory unit 401 storing all of data to be displayed through the first and the second display panels and a plurality of decoders 405, 406 and 407 for selecting an address.

In this example, three different decoders are illustrated; they are an X-address decoder 406 for selecting an X-address of the memory unit 401, a Y-address decoder 407 for selecting a Y-address for the memory unit 401 and a line address decoder 405 for transferring data of the memory unit 401 selected by the X-address decoder 406 and the Y-address decoder 407 to a latch unit 412.

Herein, the CPU interface control unit 410 accesses data of the memory unit 401 through the X-address decoder 406 and the Y-address decoder 407 at a unit of 8 or 16 bits. The line address decoder 405 is to access the data to be latched in the latch unit 412 in a line unit when a pulse signal is generated from the timing control unit 408 for latching data.

A voltage generation unit 402 supplies power voltages corresponding to operation voltage for each display panel. The latch unit 412 latches the data provided by the line address decoder 405 to thereby display the data.

For each display panel operation, a plurality of display panel drivers 403A and 403B are prepared. A switching unit 404 is used for controlling an on-off state of the display panel drivers 403A and 403B. Also, a register unit 411 is prepared for deciding an independent operation for each display panel. For example, the first display panel may use a 4096 color operation and the second display panel may use a 256 color operation, or the first display panel may use a mono operation and the second display panel may use a 65,000 color operation.

More specifically, the register unit 411 is capable of realizing the color operation of each display panel as described above. Also, the register unit 411 has information for deciding operation conditions such as an address range of each display panel, a voltage level and so on.

Accordingly, the timing control unit 408 generates a kind of pulse informing an appropriate timing for getting each display panel operated independently, for example, a point of time to start a latching or decoding operation.

The voltage generation unit 402 includes a DC/DC booster adjustable according to selection of the first and second display panels or a voltage converter capable of adjusting a voltage value according to information for selecting the display panel in the register unit 411. A part of the voltage generation unit 402 is used for operating the first display panel through a first display panel driver 403A. Herein, this part is expressed with slanting lines. The rest or whole part of the voltage generation unit 402 is used for operating the second display panel through a second display panel driver 403B. In short, the part expressed with the slanting lines is commonly used by both of the display panel drivers 403A and 403B.

Each of the X-address decoder 406, the Y-address decoder 407 and the line address decoder 405, the voltage generation unit 402, the latch unit 412, the memory unit 401 and the register unit 411 is used when the two display panels are concurrently or cooperatively operated.

If the on/off operation state of the first display penal 403A or the second display penal 403B is informed through an external interface, the memory unit 401 used by a control signal of the panel control unit 409, the line address decoder 405, the first and the second panel drivers 403A and 403B, the DC/DC booster and the display panels can be operated independently.

In case of operating a large size of display panel of the two display panels, the DC/DC booster of the voltage generation unit 402 adjusts a clock frequency thereof or reduces the size of a transistor thereof. Also, unnecessary power consumption is reduced because the output state of the memory unit 401 or the address decoder 405, 406 or 407 is decided by the on-off operation state of the display panel.

As mentioned above, there are two panel drivers 403A and 403B. At this time, only one of the two display panels may become an off-state to thereby reduce the unnecessary power consumption.

In the circuit constitution shown in FIG. 4, the memory can be shared by the display panels. In more detail, the memory is shared by using a time scheduling. In constituting the above-described circuit, a register corresponding to each display panel should be prepared for setting an operation condition decided by the size of the display panel, or a timing adjustment should be carried out for the same reason by adjusting the frequency of the DC/DC booster or the size of the operation circuit with a command.

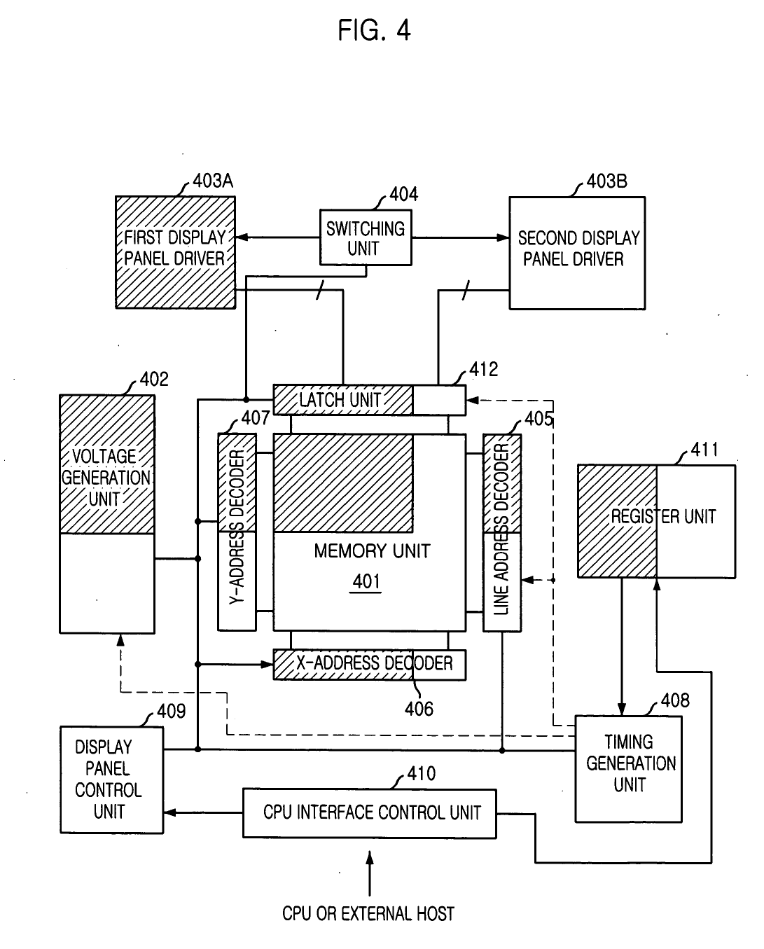

FIG. 5 is a circuit diagram illustrating the voltage generation unit 402 in FIG. 4 in accordance with the present invention.

A source voltage is provided to the voltage generation unit 402 and the voltage generation unit 402 generates voltages necessary for operating each display panel in response to a selection signal SEL and clock signals clka and clkb. When the selection signal is a logic high signal, the large size of display panel is operated, and when the selection signal is a logic low signal, the small size of display panel is operated.

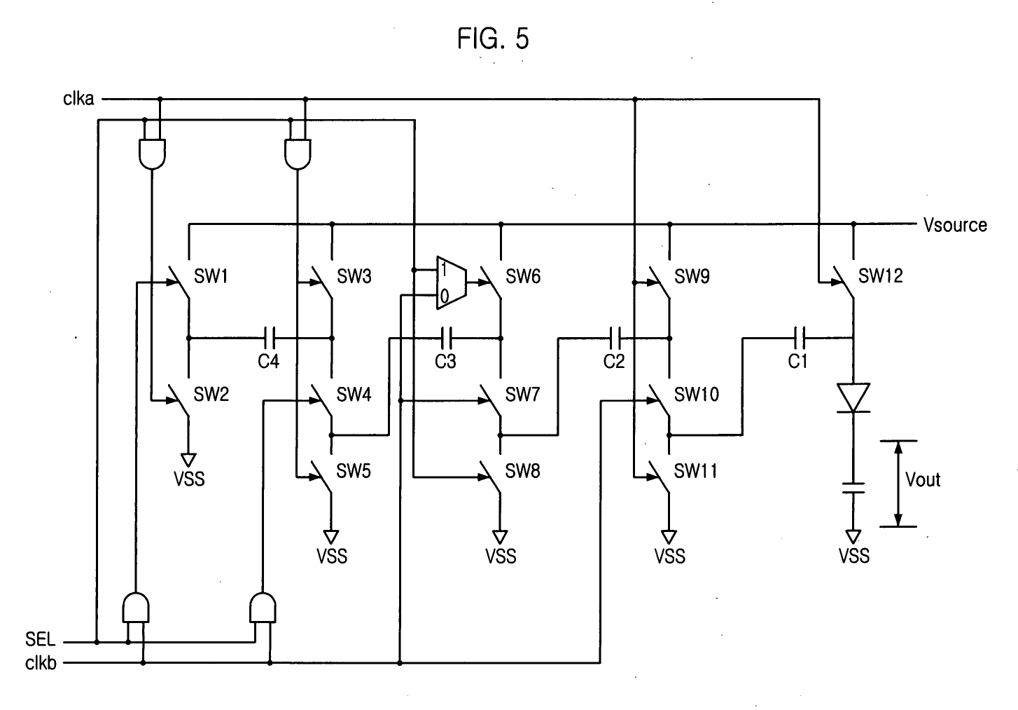

FIG. 6 is a waveform of the clock signals clka and clkb applied to the voltage generation unit 402 in accordance with the present invention.

Referring to FIGS. 5 and 6, when the selection signal is a signal of a logic high level, the voltage generation unit 402 provides a voltage of 5×Vsource to the large size of display panel and, when the selection signal is a signal of a logic low level, the voltage generation unit 402 provides a voltage of 3×Vsource to the small size of display panel.

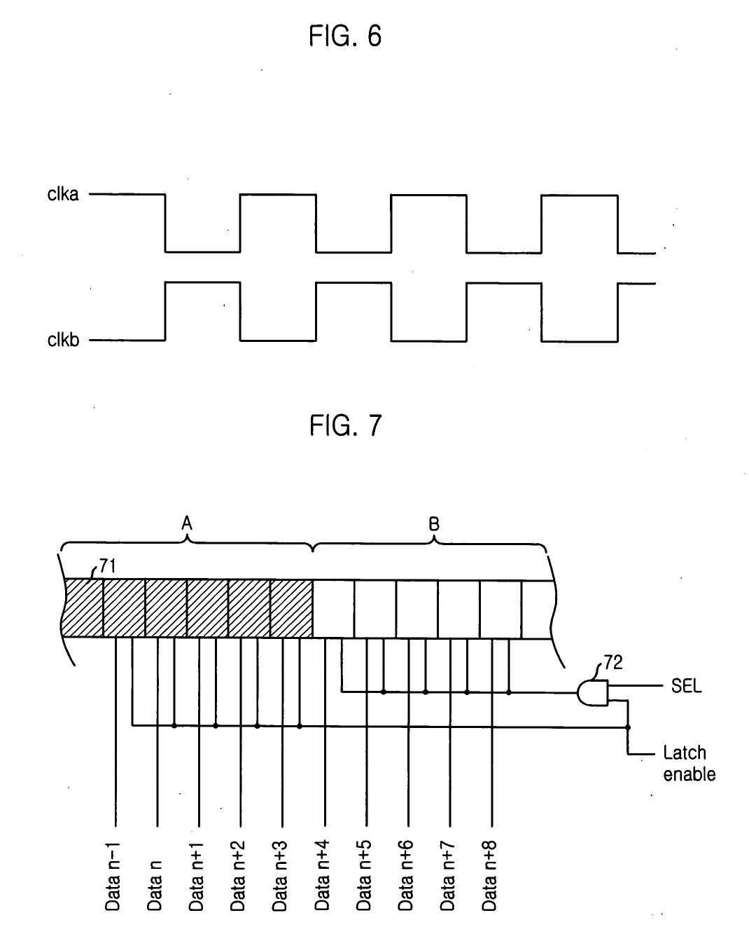

FIG. 7 is schematic diagram illustrating the latch unit 412 in FIG. 4 in accordance with the present invention.

As shown, the latch unit 412 includes a latch array having a plurality of unit latches 71 and an AND gate. The latch array holds a plurality of data Data n−1, Data n, . . . , Data n+7 and Data n+8, which are transferred from the memory unit 401 by the line address decoder 405. The latch array is divided into two parts A and B. The part A is used for the small size of display panel and all parts A and B are used for the large size of display panel. The AND gate receives the selection signal and a latch enable signal. When the large size of display panel is enabled, the latch enable signal is activated in a logic high level signal and the selection signal is a logic high level. When operating the small size of display panel, the selection signal becomes a signal of logic low level, so that the part B of the latch array is disabled.

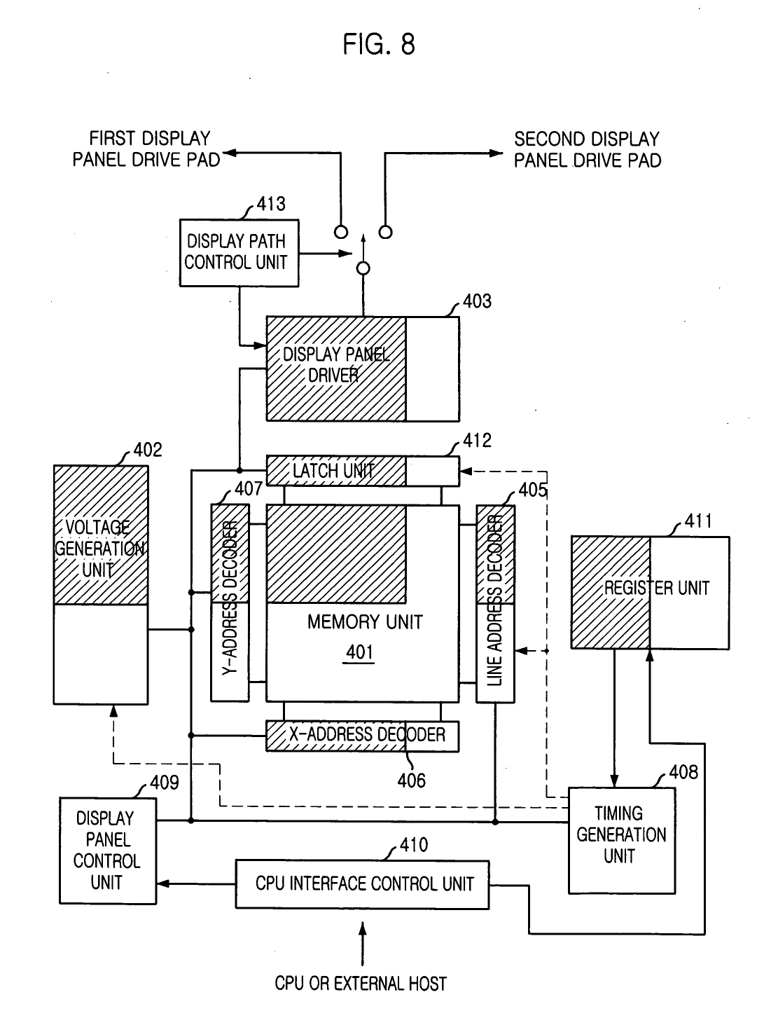

FIG. 8 is a block diagram showing another embodiment of the display panel driving unit in the display apparatus according to the present invention.

Differently from the display panel driving unit in FIG. 4, a plurality of display panel drivers do not exist. Only one display panel driver 403 is shared by a plurality of display panels and a path leading to the display panel driver 403 allocated for each display panel operation of a display panel driver channel is selected by a display path control unit 403.

When the display path control unit 413 controls the display panel driver 403 to operate the corresponding display panel, a selected part of the display panel driver 403 is, however, merely operated. At this time, the path connected with a corresponding display panel drive pad is selected by a switching operation as expressed with an arrow in FIG. 8 and thereby, operating the corresponding display panel. Other elements are identically operated to that in FIG. 4.

Consequently, a display panel driving unit area can be prominently reduced by sharing only one display panel driver.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A display apparatus, comprising:
a plurality of display panels, each showing different displays;
a single display panel driving unit for commonly operating the display panels; and
a connection means for physically and electrically inter-connecting the display panel driving unit with the display panels.

2. The display apparatus as recited in claim 1, wherein the display panels includes a first display panel and a second display panel, and rear sides of the first and the second display panels face each other with the display panel driving unit disposed between the first and the second display panels.

3. The display apparatus as recited in claim 1, wherein the connection means is formed by using one method selected from a group consisting of a tape carrier package (TCP) method, a chip on film (COF) method, a chip on board (COB) method and a chip on glass (COG).

4. The display apparatus as recited in claim 1, wherein the display panel driving unit comprises a plurality of display panel drivers for operating each of the display panels and a switching unit for switching the display panel drivers.

5. The display apparatus as recited in claim 1, wherein the display panel driving unit further comprises a display path control unit for controlling a path connected with a display panel drive pad of a selected display panel in order to operate the selected display panel.

6. The display apparatus as recited in claim 5, wherein the display panel driving unit further comprises:
a CPU interface control unit for controlling constitution elements included in the display panel driving unit by receiving a command from an external host or a central processing unit;
a display panel control unit for controlling the display panel with an external control signal transmitted through the CPU interface control unit or an independent port;
a memory unit for storing data displayed on the display panels;
an X or an Y address decoder for selecting a corresponding address of the memory unit by decoding an encoding signal outputted from the display panel control unit;
a register unit for informing each independent operation condition of the display panels;
a timing control unit for controlling a point of time for decoding, latching and displaying a data for the selected display panel by the information obtained from the register unit;
a line address decoder for decoding an address for the data of the corresponding display panel at a line unit by responding to an output of the timing control unit;
a latch unit for latching the data corresponding to the address decoded at the line unit, wherein the data is transferred from the memory unit; and
a voltage generation unit for supplying a power voltage for operating each display panel.

7. The display apparatus as recited in claim 6, wherein the display panels share the X and the Y address decoders, the line address decoder, the voltage generation unit, the memory unit and register unit during a concurrent and cooperative operation.

8. The display apparatus as recited in claim 6, wherein the voltage generation unit comprises a voltage converter and a DC/DC booster controlled by on-off states of the first and second display panels.

9. The display apparatus as recited in claim 9, wherein a clock frequency of the DC/DC booster is adjusted and the size of a transistor of the DC/DC booster is reduced in case of operating a large display panel of the display panels, and an output state of the memory unit 401 or the address decoder is decided according to on-off operation states of the first and the second display panels and consequently, the memory unit is partially accessed.
